(19) United States
(12) Patent Application Publication
(10) Pub. No.: US 2026/0250167 A1
(43) Pub. Date: Aug. 27, 2026

(54) ADVANCED OXIDATION SYSTEM IN TREATMENT OF CONTAMINANTS IN WATER AND METHOD FOR TREATMENT OF CONTAMINANTS IN WATER

(71) Applicants: Zihao Wu, Zhuhai City (CN); BEIJING NORMAL UNIVERSITY AT ZHUHAI, Zhuhai City (CN)

(72) Inventors: Zihao WU, Zhuhai City (CN); Shengrui WANG, Zhuhai City (CN); Fuqiang FAN, Zhuhai City (CN); Zhaokang LI, Zhuhai City (CN); Chunyang ZHOU, Zhuhai City (CN)

(73) Assignees: Zihao WU, Zhuhai City, GD (CN); BEIJING NORMAL UNIVERSITY AT ZHUHAI, Zhuhai City (CN)

(21) Appl. No.: 19/221,395

(22) Filed: May 28, 2025

(30) Foreign Application Priority Data
Feb. 26, 2025 (CN) 202510224343.4
Mar. 10, 2025 (CN) 202510281888.9

(51) Int. Cl. C02F 1/76; C02F 1/32; C02F 1/36; C02F 101/38

(52) U.S. Cl. CPC C02F 1/76; C02F 1/325; C02F 1/36; C02F 2101/38; C02F 2301/063; C02F 2305/08

(57) ABSTRACT

An advanced oxidation system for treatment of contaminants in water and a method for treatment of contaminants in water are provided. The advanced oxidation system includes a chlorine-containing substance, vacuum ultraviolet irradiation, and bubbles, where the bubbles comprise at least one selected from the group consisting of nano bubbles and micron bubbles. The method includes: adding a chlorine-containing substance to the water containing the contaminants, and generating bubbles in situ in the water using a bubble generator while irradiating the water with vacuum ultraviolet light.

### CROSS REFERENCE TO RELATED APPLICATION

This patent application claims the benefits and priorities of Chinese Patent Application No. 202510224343.4 filed with the China National Intellectual Property Administration on Feb. 26, 2025, and Chinese Patent Application No. 202510281888.9 filed with the China National Intellectual Property Administration on Mar. 10, 2025. The disclosures of the two applications each are incorporated by reference herein in its entirety as part of the present application.

### TECHNICAL FIELD

The present disclosure belongs to the technical field of wastewater treatment, and in particular relates to use of an advanced oxidation system in the treatment of contaminants in water and a method for treatment of contaminants in water.

### BACKGROUND OF THE INVENTION

With the continuous development of various industries, a large amount of difficult-to-degrade chemicals are produced and discharged into water, causing environmental risks and posing harm to organisms and humans in the environment.

Therefore, it is necessary to degrade contaminants in water. Advanced oxidation processes (AOPs) are effective treatment methods. The vacuum ultraviolet direct irradiation technology mainly uses a mercury lamp, a xenon lamp, etc., to generate vacuum ultraviolet (VUV) and directly irradiate water, producing strong oxidative HO· and reductive species e_{aq} and H·. The e_{aq} and H· are easily consumed by dissolved oxygen (DO), so a substance that plays the main role in removing contaminants is HO·, resulting in a single active species. Moreover, the active species HO· is susceptible to the influence of background substances in water, leading to a decreased contaminant removal efficiency.

### SUMMARY OF THE INVENTION

An object of the present disclosure is to provide use of an advanced oxidation system in treatment of contaminants in water and a method for treatment of contaminants in water. The advanced oxidation system provided by the present disclosure exhibits a higher contaminants removal efficiency in water.

To achieve the object described above, the present disclosure provides the following technical solutions.

The present disclosure provides use of an advanced oxidation system in treatment of contaminants in water, where the advanced oxidation system includes a chlorine-containing substance (FC), vacuum ultraviolet (VUV) irradiation, and bubbles, where the bubbles include at least one selected from the group consisting of nano bubbles and micron bubbles.

In some embodiments, the bubbles have an average diameter of 6 nm to 100 μm.

In some embodiments, a generator for generating the bubbles includes at least one selected from the group consisting of a hydraulic cavitation generator, an ultrasonic cavitation generator, an electrolytic cavitation generator, and a chemical reaction generator.

In some embodiments, the bubbles generated by the hydraulic cavitation generator have an average diameter of 32 nm to 100 μm;
the bubbles generated by the ultrasonic cavitation generator have an average diameter of 6 nm to 60 nm;
the bubbles generated by the electrolytic cavitation generator have an average diameter of 50 nm to 20 μm; and
the bubbles generated by the chemical reaction generator have an average diameter of 60 nm to 500 nm.

In some embodiments, a light source for the VUV irradiation includes at least one selected from the group consisting of a VUV lamp, a xenon lamp, a low-pressure mercury lamp, a medium-pressure mercury lamp, a high-pressure mercury lamp, an amalgam ultraviolet lamp, and a Light Emitting Diode (LED) lamp.

In some embodiments, the FC includes at least one selected from the group consisting of free chlorine, chlorine gas, chlorine dioxide, and a chloramine;
the free chlorine includes at least one selected from the group consisting of hypochlorous acid and a hypochlorite salt; wherein the hypochlorite salt includes at least one selected from the group consisting of potassium hypochlorite, sodium hypochlorite, calcium hypochlorite, and ammonium hypochlorite; and
the chloramine includes at least one selected from the group consisting of monochloroamine, dichloroamine, and trichloroamine.

The present disclosure further provides a method for treatment of contaminants in water, includes the following steps:
adding the FC to water containing contaminants, and generating bubbles in situ in the water using a bubble generator while irradiating the water with a VUV light.

In some embodiments, the contaminants include at least one selected from the group consisting of an antiepileptic drug, an antibiotic, and an industrial chemical; wherein
the antiepileptic drug includes at least one selected from the group consisting of carbamazepine, phenytoin, phenobarbital, primidone, and sodium valproate;
the industrial chemical includes at least one selected from the group consisting of nitrobenzene, cyclohexanoic acid, p-chlorobenzoic acid, and trichloroethylene acid; and
the antibiotic includes at least one selected from the group consisting of tetracyclines, quinolones, macrolides, sulfonamides, beta-lactam antibiotics, and broad-spectrum antibiotics.

In some embodiments, the contaminants in the water have a concentration of 5 μM to 250 μM;

the FC in the water has a concentration of 50 μM to 1,250 M; and a molar ratio of the contaminants to the FC is not less than 1:1.

In some embodiments, the VUV irradiation is conducted for not less than 20 min.

The present disclosure provides use of an advanced oxidation system in the treatment of contaminants in water, where the advanced oxidation system includes the FC, VUV irradiation, and the bubbles, where the bubbles include at least one selected from the group consisting of nano bubbles and micron bubbles.

In the present disclosure, the FC is used to convert e_{aq} and H· generated by VUV light into effective free radicals reactive chlorine species (RCS), which participate in the removal of the contaminants, avoid adverse consumption of dissolved oxygen, and enrich the types of active species. In addition, the advanced oxidation system provided by the present disclosure could produce not only HO· but also RCS, and RCS is less influenced by background substances in water than HO·. In addition, micro/nano-bubbles (MNB) are introduced into the system, which could cause turbulent flow in the water, improve mass-transfer efficiency, increase the optical path, generate reactive oxygen species (ROS), and effectively enhance the mass-transfer efficiency of reactive species, thereby improving the contaminant removal efficiency. The present disclosure could improve the impact resistance of water treatment conditions and significantly enhance the contaminant removal efficiency by constructing a coupled system of FC, VUV irradiation, and bubbles (such as MNB).

### BRIEF DESCRIPTION OF THE DRAWINGS

FIG. 1 shows the removal efficiency for carbamazepine by a VUV/FC/MNB system, a VUV system, an FC system, and a VUV/FC system.

FIG. 2 shows the contribution of different active substances to the degradation of carbamazepine in the VUV/FC/MNB system.

FIG. 3 shows the influence of pH value on the contribution of different active substances in the system to the degradation of carbamazepine.

### DETAILED DESCRIPTION OF THE EMBODIMENTS

The present disclosure provides use of an advanced oxidation system in the treatment of contaminants in water, where the advanced oxidation system includes a FC, VUV irradiation, and bubbles, where the bubbles include MNB.

In some embodiments of the present disclosure, the bubbles have an average diameter of 6 nm to 100 μm. In some embodiments of the present disclosure, a generator for generating the bubbles includes at least one selected from the group consisting of a hydraulic cavitation generator, an ultrasonic cavitation generator, an electrolytic cavitation generator, and a chemical reaction generator.

In some embodiments of the present disclosure, the bubbles generated by the hydraulic cavitation generator have an average diameter of 32 nm to 100 μm. In some embodiments of the present disclosure, the bubbles generated by the ultrasonic cavitation generator have an average diameter of 6 nm to 60 nm. In some embodiments of the present disclosure, the bubbles generated by the electrolytic cavitation generator have an average diameter of 50 nm to 20 μm. In some embodiments of the present disclosure, the bubbles generated by the chemical reaction generator have an average diameter of 60 nm to 500 nm. In some embodiments of the present disclosure, a light source for VUV irradiation includes at least one selected from the group consisting of a VUV lamp, a xenon lamp, a low-pressure mercury lamp, a medium-pressure mercury lamp, a high-pressure mercury lamp, an amalgam ultraviolet lamp, and an LED lamp.

In some embodiments of the present disclosure, the FC includes at least one selected from the group consisting of free chlorine, chlorine gas, chlorine dioxide, and a chloramine. In some embodiments of the present disclosure, the free chlorine includes at least one selected from the group consisting of hypochlorous acid and a hypochlorite salt. In some embodiments of the present disclosure, the hypochlorite salt includes at least one selected from the group consisting of potassium hypochlorite, sodium hypochlorite, calcium hypochlorite, and ammonium hypochlorite. In some embodiments of the present disclosure, the chloramine includes at least one selected from the group consisting of monochloroamine, dichloroamine, and trichloroamine.

In the present disclosure, the VUV/FC/MNB system exhibits a higher contaminant removal efficiency. The VUV/FC/MNB system, in addition to the active species generated by both subsystems, further exhibits a synergistic effect, which involves a conversion between active species in the system and the improvement of mass-transfer efficiency of active species. Specifically, the e_{aq}⁻ and H· generated by VUV-excited water could participate in the activation of FC, promoting the generation of active free radicals in the system. HO· itself has a good oxidation effect. However, the HO· lacks selectivity in degrading a wide range of contaminants and is easily consumed by water-quality background substances, which reduces its efficiency in removing contaminants. The reaction between HO· and Cl· produces ClO·. The oxidation-reduction potentials of Cl· and ClO· are 2.4 V and 1.5 V, respectively, both lower than HO·. However, both Cl· and ClO· have a higher selectivity for substances than HO·. and are not easily consumed by water-quality background substances, which could compensate for the reduced efficiency of HO·. In addition, the participation of MNB further improves the mass-transfer efficiency of the active species, leading to an improved contaminant removal efficiency to a certain extent.

The present disclosure further provides a method for treatment of contaminants in water, includes the following steps:
adding the FC to the water containing the contaminants, and generating bubbles in situ in the water using the bubble generator while irradiating the water with the VUV light.

In some embodiments of the present disclosure, the contaminants include at least one selected from the group consisting of an antiepileptic drug, an antibiotic, and an industrial chemical. In some embodiments of the present disclosure, the antiepileptic drug includes at least one selected from the group consisting of carbamazepine, phenytoin, phenobarbital, primidone, and sodium valproate. In some embodiments of the present disclosure, the industrial chemical includes at least one selected from the group consisting of nitrobenzene, cyclohexanoic acid, p-chlorobenzoic acid, and trichloroethylene acid. In some embodiments of the present disclosure, the antibiotic includes at least one selected from the group consisting of tetracyclines, quinolones, macrolides, sulfonamides, beta-lactam antibiotics, and broad-spectrum antibiotics. In some embodiments of the present disclosure, the tetracyclines include at least one selected from the group consisting of tetracycline, chlortetracycline, and oxytetracycline. In some embodiments of the present disclosure, the quinolones include at least one selected from the group consisting of norfloxacin, ciprofloxacin, ofloxacin, and nalidixic acid. In some embodiments of the present disclosure, the macrolides are at least one selected from the group consisting of erythromycin, azithromycin, roxithromycin, and clarithromycin. In some embodiments of the present disclosure, the sulfonamides include at least one selected from the group consisting of sulfamethazine, sulfafurazole, sulfadiazine, sulfamethoxazole, sulfamethoxydiazine, and sulfadimethoxine. In some embodiments of the present disclosure, the beta-lactam antibiotics include at least one selected from the group consisting of penicillin, ampicillin, amoxicillin, cefaloridine, and cefadroxil. In some embodiments of the present disclosure, the broad-spectrum antibiotics include at least one selected from the group consisting of trimethoprim, metronidazole, and tinidazole.

In the present disclosure, the contaminants in the water have a concentration of 5 μM to 250 μM. In some embodiments of the present disclosure, the FC in the water have a concentration of 50 μM to 1,250 μM. In some embodiments of the present disclosure, a molar ratio of the contaminants to the FC is not less than 1:1.

In some embodiments of the present disclosure, the VUV irradiation is conducted for not less than 20 min.

Unless otherwise specified, the materials and equipment used in the present disclosure are commercially available in the art.

The technical solutions in the present disclosure will be described clearly and completely below with reference to the examples of the present disclosure. Apparently, the described examples are merely a part of, rather than all of the examples of the present disclosure. Based on the examples of the present disclosure, all other examples that can be obtained by those of ordinary skill in the art without creative efforts shall fall within the scope of the present disclosure.

### Example 1

An aqueous solution containing carbamazepine having a concentration of 5 μM was prepared as simulated wastewater, and sodium hypochlorite was added thereto. The concentration of the FC in the aqueous solution is 100 μM, and a molar ratio of carbamazepine to sodium hypochlorite is 1:1. Nano bubbles having an average diameter of 60 nm was generated in situ in a resulting solution by using an ultrasonic cavitation generator, and the resulting solution was subjected to irradiation (VUV/FC/MNB) by using a low-pressure mercury lamp simultaneously. During the irradiation, the concentration changes of carbamazepine in the resulting solution was detected.

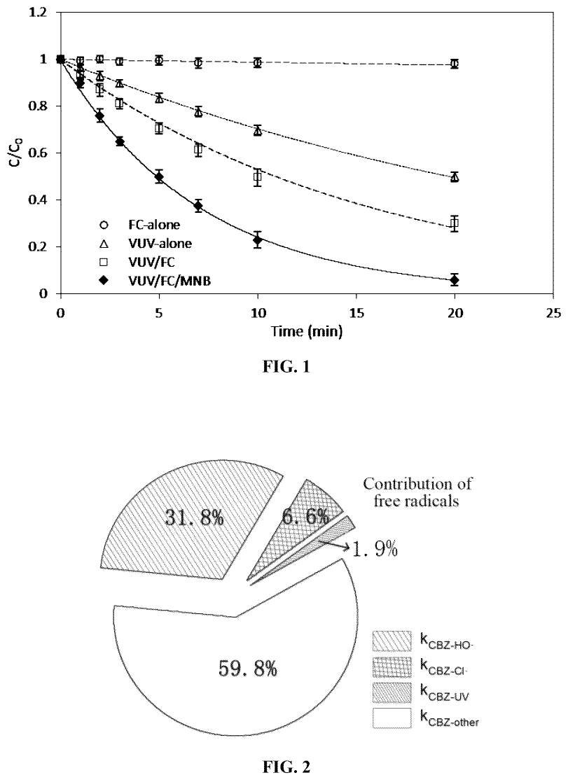

The concentration changes of carbamazepine were tested, with VUV irradiation alone (VUV), addition of FC alone (FC), and VUV irradiation combined with FC (VUV/FC) as controls. The test results are shown in FIG. 1 and Table 1.

TABLE 1
Concentration changes of carbamazepine (20 min)

| | VUV/FC/MNB | VUV | FC | VUV/FC |
|---|---|---|---|---|
| Removal rate | 94.4% | 51.4% | 0.2% | 68.3% |

As can be seen from Table 1, the VUV/FC/MNB system according to the present disclosure could effectively improve the removal efficiency for contaminants in water.

FIG. 2 shows the contribution of different active substances to the degradation of carbamazepine in the VUV/FC/MNB system. As can be seen from FIG. 2, Cl· contributes the most to the degradation of the system, accounting for 59.8% of the total contribution to the degradation of carbamazepine, and plays a dominant role in the degradation of carbamazepine in the system. HO· contributes lower than Cl·, which accounts for 31.8% of the total contribution to the degradation of carbamazepine. Ultraviolet light alone has little effect on carbamazepine, and the contribution of the pseudo-first-order rate to the system is usually only 1.9%. Other free radicals were generated in the system due to the photolysis of VUV and the oxidation of HO· and Cl· and have a contribution rate of 6.6%.

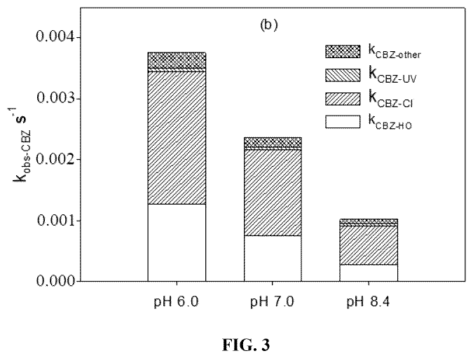

FIG. 3 shows the effect of pH value on the contribution of different active substances in the system to the degradation of carbamazepine. As can be seen from FIG. 3, the total degradation efficiency for carbamazepine by the system decreased with pH value increased from 6.0 to 8.4, and the degradation efficiency for carbamazepine by Cl· and HO·, which play a major role, decreased by 71.1% and 77.9%, respectively.

Although the embodiments described above have provided a detailed description of the present disclosure, they are only a part of, rather than all of the embodiments of the present disclosure. All other embodiments that can be obtained according to the embodiments of the present disclosure without creative efforts shall fall within the scope of the present disclosure.

What is claimed is:

1. An advanced oxidation system for treatment of contaminants in water, comprising a chlorine-containing substance, vacuum ultraviolet irradiation, and bubbles;
wherein the bubbles comprise at least one selected from the group consisting of nano bubbles and micron bubbles.

2. The advanced oxidation system of claim 1, wherein the bubbles have an average diameter of 6 nanometers (nm) to 100 micrometers (μm).

3. The advanced oxidation system of claim 1, wherein a generator for generating the bubbles comprises at least one selected from the group consisting of a hydraulic cavitation generator, an ultrasonic cavitation generator, an electrolytic cavitation generator, and a chemical reaction generator.

4. The advanced oxidation system of claim 3, wherein the bubbles generated by the hydraulic cavitation generator have an average diameter of 32 nm to 100 μm;
the bubbles generated by the ultrasonic cavitation generator have an average diameter of 6 nm to 60 nm;
the bubbles generated by the electrolytic cavitation generator have an average diameter of 50 nm to 20 μm; and
the bubbles generated by the chemical reaction generator have an average diameter of 60 nm to 500 nm.

5. The advanced oxidation system of claim 1, wherein a light source for the vacuum ultraviolet irradiation comprises at least one selected from the group consisting of a vacuum ultraviolet lamp, a xenon lamp, a low-pressure mercury lamp, a medium-pressure mercury lamp, a high-pressure mercury lamp, an amalgam ultraviolet lamp, and a Light Emitting Diode (LED) lamp.

6. The advanced oxidation system of claim 1, wherein the chlorine-containing substance comprises at least one selected from the group consisting of free chlorine, chlorine gas, chlorine dioxide, and a chloramine;
the free chlorine comprises at least one selected from the group consisting of hypochlorous acid and a hypochlorite salt, wherein the hypochlorite salt comprises at least one selected from the group consisting of potassium hypochlorite, sodium hypochlorite, calcium hypochlorite, and ammonium hypochlorite; and
the chloramine comprises at least one selected from the group consisting of monochloroamine, dichloroamine, and trichloroamine.

7. The advanced oxidation system of claim 2, wherein a generator for generating the bubbles comprises at least one selected from the group consisting of a hydraulic cavitation generator, an ultrasonic cavitation generator, an electrolytic cavitation generator, and a chemical reaction generator.

8. A method for treatment of contaminants in water, comprising the following steps:
adding a chlorine-containing substance to the water containing the contaminants, and generating bubbles in situ in the water using a bubble generator while irradiating the water with a vacuum ultraviolet light.

9. The method of claim 8, wherein the contaminants comprise at least one selected from the group consisting of an antiepileptic drug, an antibiotic, and an industrial chemical; wherein
the antiepileptic drug comprises at least one selected from the group consisting of carbamazepine, phenytoin, phenobarbital, primidone, and sodium valproate;
the industrial chemical comprises at least one selected from the group consisting of nitrobenzene, cyclohexanoic acid, p-chlorobenzoic acid, and trichloroethylene acid; and
the antibiotic comprises at least one selected from the group consisting of tetracyclines, quinolones, macrolides, sulfonamides, beta-lactam antibiotics, and broad-spectrum antibiotics.

10. The method of claim 8, wherein the contaminants in the water have a concentration of 5 micromolar (UM) to 250 μM;
the chlorine-containing substance in the water has a concentration of 50 μM to 1,250 μM; and
a molar ratio of the contaminants to the chlorine-containing substance is not less than 1:1.

11. The method of claim 8, wherein the vacuum ultraviolet irradiation is conducted for not less than 20 minutes (min).

12. The method of claim 9, wherein the contaminants in the water have a concentration of 5 μM to 250 μM;
the chlorine-containing substance in the water has a concentration of 50 μM to 1,250 μM; and
a molar ratio of the contaminants to the chlorine-containing substance is not less than 1:1.
